(19) United States
(12) Patent Application Publication
(10) Pub. No.: US 2002/0126059 A1
(43) Pub. Date: Sep. 12, 2002

(54) Cellular base station antenna

(76) Inventors: Martin L. Zimmerman, Chicago, IL (US); Jamie Paske, Darien, IL (US); Jim Giacobazzi, Bloomingdale, IL (US); Kevin E. Linehan, Justice, IL (US)

Correspondence Address: ERIC D. COHEN, ESQ., WELSH & KATZ, LTD, 120 SOUTH RIVERSIDE PLAZA, 22ND FLOOR, CHICAGO, IL, 60606, US

(21) Appl. No.: 09/788,790

(22) Filed: Feb. 19, 2001

(51) Int. Cl. H01Q 3/00

(52) U.S. Cl. 343/757

(57) ABSTRACT

An antenna assembly for emitting a signal. The antenna assembly includes at least two antennas which are separated into a first group and a second group. Both groups of antennas are mounted on a panel. A first phase adjuster is coupled to the first antenna group. The first phase adjuster is also coupled to a second phase adjuster, which is also coupled to said second antenna group. The first phase adjuster is coupled to the second phase adjuster, such that an adjustment of the first phase adjuster causes an adjustment of the second phase adjuster. The first phase adjuster is adapted to adjust a phase angle of the signal of the first antenna group, while the second phase adjuster is adapted to adjust a phase angle of the signal of said second antenna group.

### FIELD OF THE INVENTION

The present invention relates generally to an antenna assembly having variable radiation patterns and, more particularly, to a phase shifting assembly for an antenna assembly having a variable radiation downtilt angle which is electrically adjustable.

### BACKGROUND OF THE INVENTION

In many passive antenna assemblies, it is often desired to be able to adjust a radiation pattern of the antenna assembly after the antenna assembly has been installed on a tower. The need may arise due to a number of factors, including new construction, which may create obstacles, vegetation growth, or other changes in the surrounding environment. It may also be desired to alter the radiation pattern due to performance studies or to alter the shape of the area the antenna covers.

There are various ways that the radiation pattern may be altered. One method is to physically change the location of the antenna assembly. Once the assembly has been installed on a tower, however, this becomes difficult. It is also possible to change the azimuth and elevation of the individual antennas, but such a method is expensive when applied to several antennas. Also, the mechanical device required to adjust the azimuth and elevation may interfere with the mechanical antenna mount.

Another method that has been utilized to adjust the radiation pattern of a number of antennas grouped onto one antenna assembly is to alter the phase angle of the individual antennas. By altering the phase angle of the individual antennas, a main beam (which causes the radiation pattern) is tilted relative to the surface of the earth. The antennas are grouped into a first group, a second group, and a third group. All three groups are disposed along a panel of the antenna assembly. A phase adjuster is disposed between two of the antenna groups, such that an adjustment of the phase adjuster changes the radiation pattern. The phase adjuster comprises a conductor coupled with a transmission line to create a capacitor. The conductor is rotatable and moves along the transmission line, changing the location of the capacitor on the transmission line. The transmission line is coupled to an antenna which has a phase angle. The phase angle is dependant partially on the location of the capacitor. Thus, by changing the location of the capacitor, the phase angle is changed. The phase adjuster may be coupled to a plurality of antennas and acts to adjust the phase angle of all of them.

The phase adjusters currently in use, however, have numerous drawbacks. First, the conductor is often made of brass which is expensive to etch and cut. Therefore, the conductor is usually cut in a rectangular shape. The path of the transmission line, however, is arcuate. The conductor does not cover the entire width at the capacitor, which decreases the effectiveness of the capacitance.

Another problem with current phase adjusters is the coupling of a power divider to the phase adjuster. The antenna assembly receives power from one source. Each of the three groups of antennas, however, has different power requirements. Thus, power dividers must be connected to the assembly. Currently, a power divider may be a series of cables having different impedances. Using a variety of cables makes manufacturing difficult since the cables have to be soldered together. Also, since manual work is required, the chances of an error occurring is increased. Another method of dividing the power is to create a power divider on a PC board and then cable the power divider to the phase adjuster. Although this decreases some costs, it still requires the extensive use of cabling, which is a disadvantage.

A third problem is caused by the use of cable lines having different lengths to connect an antenna to the appropriate output from the phase adjuster. Each antenna has a different default phase angle when the phase adjuster is set to zero. The default phase angle is a function of the cable length coupled with the length of the transmission line. To achieve the differing default phase angles, cables of varying lengths are attached to different antennas. Although this only creates a slight increase in manufacturing costs since cables of varying lengths must be purchased, it greatly increases the likelihood of error during installation. In numerous antenna assemblies, the cable lengths only differ by an inch or less. During assembly, if a cable is not properly marked, it may be difficult for the person doing the assembly to tell the difference between the different sizes of cable.

To move the phase adjuster, an actuator is located on a side of the panel and may include a small knob or rotatable disc for manually changing the phase adjuster. Thus, whenever the radiation pattern needs to be adjusted, a person must climb the tower and up the side of the panel to the phase adjuster. This is a difficult and time consuming process. Also, it is only possible to move the actuator manually, requiring the exertion of physical labor. In addition, it is a dangerous activity since the antennas are located on a tower and it is possible for a person to fall or otherwise become injured in the climbing process.

### BRIEF DESCRIPTION OF THE DRAWINGS

The foregoing and other advantages of the invention will become apparent upon reading the following detailed description and upon reference to the drawings.

FIG. 1 is a schematic of an antenna assembly of the present invention.

FIG. 2 is a schematic view of a phase adjuster assembly according to one embodiment of the present invention.

FIG. 3 is perspective side view of a panel and the phase adjuster assembly according to one embodiment of the present invention.

FIG. 4 is an enlarged view of section B shown in FIG. 3.

FIG. 5 is an enlarged view of section A shown in FIG. 3.

FIG. 6a is a front view of a bushing mount according to one embodiment of the present invention.

FIG. 6b is an end view of a bushing mount according to one embodiment of the present invention.

FIG. 6c is a side view of a bushing mount according to one embodiment of the present invention.

FIG. 7 is an exploded perspective view of an actuator rod according to one embodiment of the present invention.

FIG. 8 is a perspective view of a compression nut according to one embodiment of the present invention.

FIG. 9 is a perspective view of an actuator rod and an electrical actuator according to one embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

An antenna assembly for emitting a signal includes at least two antennas divided into two groups. A first phase adjuster is coupled to the first antenna group, and are adapted to adjust a phase angle of the first group. A second phase adjuster is coupled to the second antenna group. The second phase adjuster is adapted to adjust a phase angle of the second group. Also coupled to the second phase adjuster is the first phase adjuster, such that an adjustment of the first phase adjuster causes an adjustment of the second phase adjuster.

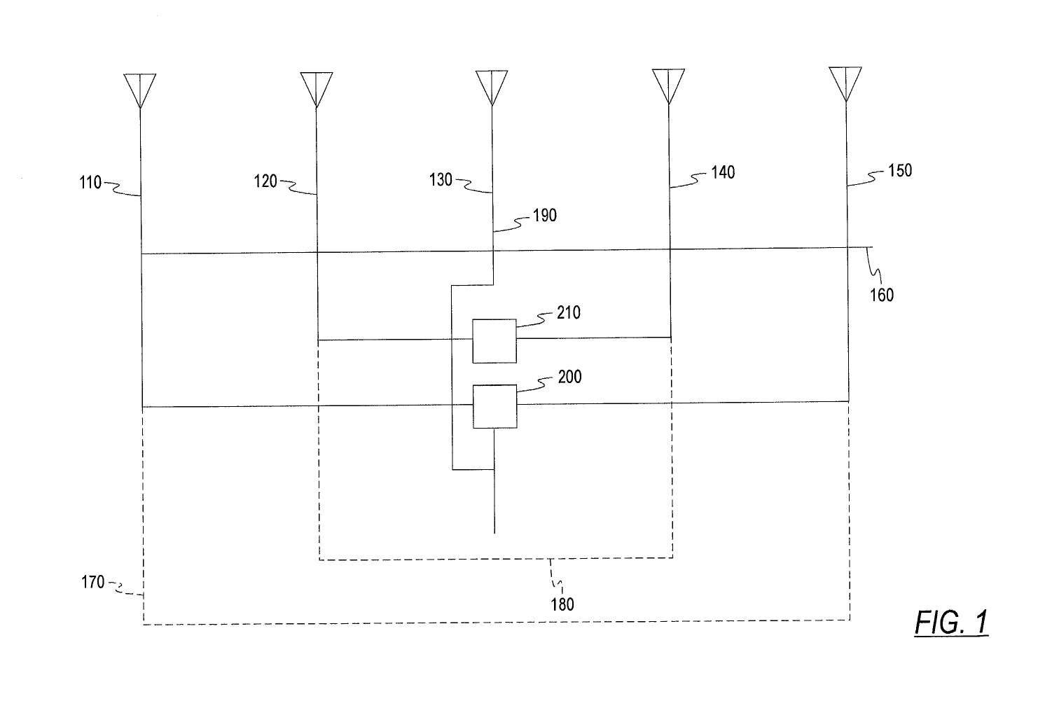

FIG. 1 is a side view of an antenna assembly 100 of the present invention. The antenna assembly 100 is comprised of a plurality of antennas 110, 120, 130, 140, 150 disposed along a panel 160. The antennas 110, 120, 130, 140, 150 are grouped into a first group 170, a second group 180, and a third group 190. The first antenna 110 and the fifth antenna 150 are in the first group 170. The second antenna 120 and the fourth antenna 140 are in the second group 180 and the third antenna 130 is in the third group 190.

To adjust the radiation pattern, the vertical electromagnetic beam of the antenna assembly 100 must be adjusted. This is accomplished by adjusting the phase angle of the first group 170 relative to the second group 180. The first group 170, however, must be adjusted by an amount different than the amount of the second group 180. To accomplish this, a first phase adjuster 200 is attached to the first group 170, and a second phase adjuster 210 is attached to the second group 180. The adjustment amount of the second group 180 is often a function of the amount of adjustment of the first group 170. To ensure that the first and second groups 170, 180 are adjusted in the correct ratio, the second adjuster 210 may be connected to the first adjuster 200, such that an adjustment of the first adjuster causes an adjustment of the second adjuster. More particularly, the second phase adjuster 210 may be connected to the first phase adjuster 200, such that an adjustment of the first phase adjuster 200 for a predetermined distance causes the second phase adjuster 210 to move proportional to the distance.

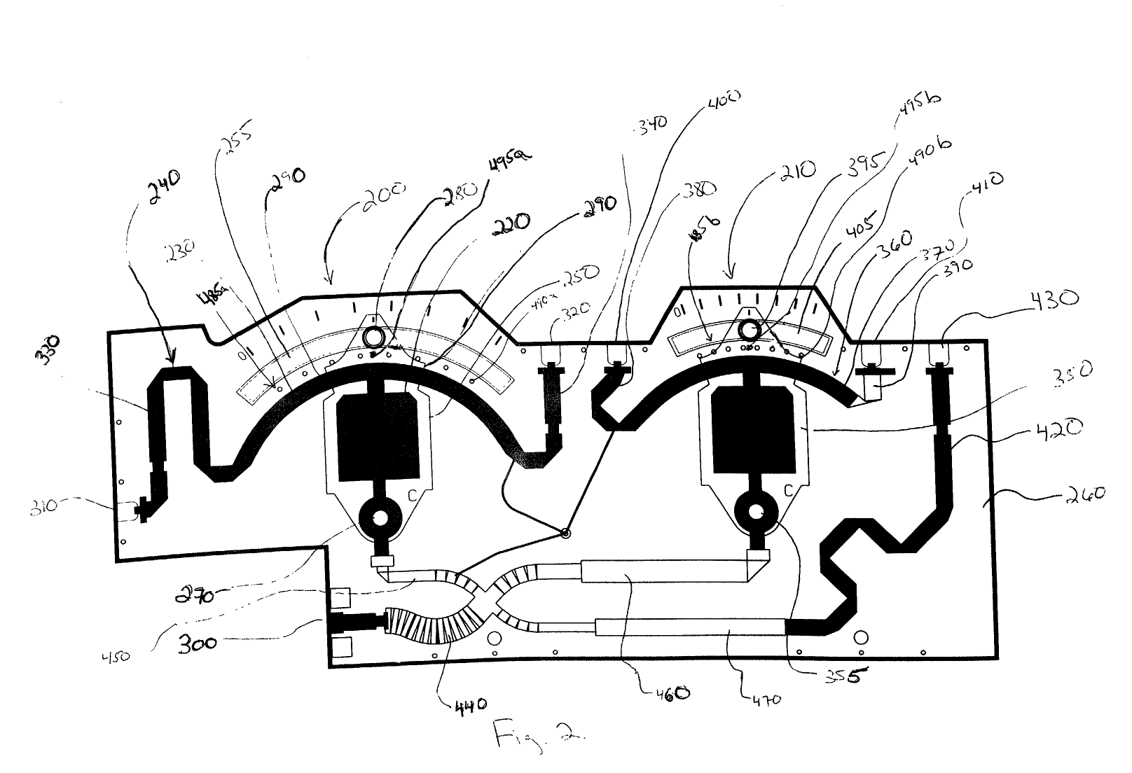

FIG. 2 depicts a schematic view of a first and second phase adjusters 200, 210 respectively, adapted to adjust the vertical beam or vertical beam downtilt angle. The first phase adjuster 200 is coupled to the first antenna group 170, and the second phase adjuster 210 is coupled to the second antenna group 180. Each of the plurality of antennas 110, 120, 130, 140, 150 has a different phase angle. By adjusting the phase angles of the plurality of antennas 110, 120, 130, 140, 150, or at least of the first and second groups 170, 180 of antennas, the vertical beam of the antenna assembly 100 is adjusted.

The first and second phase adjusters 200, 210 operate in the same fashion. For simplicity, the description will be described in more detail regarding the first phase adjuster 200. To adjust the phase angle, a conductive wiper 220 slides over a first arcuate portion 230 of a first transmission line 240. One end of the first transmission line 240 is coupled to the first antenna 110, while the other end of the first transmission line 240 is coupled to the fifth antenna 150. The conductive wiper 220 in connection with the first arcuate portion 230 acts as a capacitor. To the antennas 110, 150, the capacitor is seen as a short circuit at high frequencies. The length of the first transmission line 240 up to the point of the short circuit affects the phase angle of the antenna. As the conductive wiper 220 slides over the first arcuate portion 230, the location of the short circuit changes, changing the length of the first transmission line 240 and, thus, the phase angle of the two antennas 110, 150. Since the antennas 110, 150 are located at opposite ends of the first transmission line 240, the movement of the short circuit lengthens one transmission line as seen by one antenna while shortening the transmission line as seen by the other antenna. In other words, the transmission line has a finite length. The finite length of the transmission line is divided into a first effective length and a second effective length. The first effective length is from the first antenna 110 to the location of the wiper 220 on the transmission line 240. The second effective length is measured from the fifth antenna 150 to the location of the wiper 220 on the transmission line 240. As the wiper 220 is adjusted towards the fifth antenna 150, the first effective length is lengthened while the second effective length is shortened. As the wiper 220 is adjusted towards the first antenna 110, the first effective length is shortened while the second effective length is lengthened.

In this particular embodiment, the conductive wiper 220 is a first rotatable PC board 250 with a metallic side. The first transmission line 240 is mounted on a separate fixed PC board 260. The fixed PC board 260 and first rotatable PC board 250 act as a dielectric between the capacitor. In prior art systems, an air dielectric was sometimes used. If the conductive wiper changes its spacing relative to the first arcuate portion 230, however, the capacitor's capacitance is altered, thus, changing the impedance match of the phase shifter. If the two sections touch, the capacitance is destroyed, which adversely affects the performance of the antenna even more. Other systems use a sheet dielectric to separate the conductive wiper from the transmission line which have to be mounted using standoffs and point fasteners. The sheet, however, tends to attenuate the capacitive effect. By using the PC boards as the dielectric, the conductive wiper cannot touch the transmission line nor are the capacitive effects attenuated. Also, the manufacturing costs for making the PC board are much lower than having to mount the sheet dielectric.

The first rotatable PC board 250 is pivotally connected to the fixed PC board 260 at a joint 270, which acts as the pivot point for the first rotatable PC board 250. At another end, a joint 280, the first rotatable PC board 250 is slidably mounted in a first slot 255 which defines the range of movement of the first rotatable PC board 250. The actuator moves the first rotatable PC board 250 in an arcuate path over the first arcuate portion 230, thus, changing the phase angle of the antennas 110, 150 as discussed above.

To increase the capacitive effects, an end 290 of the first rotatable PC board 250 that glides over the first arcuate portion 230 may be curved. The radius of curvature of the end 290 of the first rotatable PC board 250 is the same as the radius of curvature of the first arcuate portion 230. Also, both the first rotatable PC board 250 and the first arcuate portion 230 have the same center point located at the joint 270. By completely aligning with the arcuate portion 230, the capacitance is increased, increasing the effectiveness of the first phase adjuster 200.

The first transmission line 240 is electrically connected to an input 300 for receiving power. The first rotatable PC board 250 is also electrically connected to the input 300. The first transmission line 240 is coupled to the first antenna 110 (shown in FIG. 1) at a first output 310, and also to the fifth antenna 150 (shown in FIG. 1) at a fifth output 320. Each of the antennas 110, 150 has a default phase angle when the capacitor is set to zero, which is marked on FIG. 2. The default phase angle is a finction of the length of the first transmission line 240 and a cable line (not shown) connecting the first transmission line 240 to the antenna 110, 150. The first transmission line 240 includes a first path 330 leading from the first arcuate portion 230 to the first output 310. The length of the first path 330 is determined by the default phase angle of the first antenna 110. The first transmission line 240 also has a second path 340 connecting the first arcuate portion 230 to the fifth output 320. The length of the second path 340 is determined by the default angle of the fifth antenna 150. By varying the length of the first path 330 and the fifth path 340, the same length cables can be used during installation to connect the antennas to the output, which makes installation easier.

The second phase adjuster 210 acts in the same way as the first phase adjuster 200. A second rotatable PC board 350 is mounted on the fixed PC board 260 and is electrically coupled to the input 300. The second rotatable PC board 350 is rotatable around a joint 355, which is also where the second rotatable PC board 350 is connected to the fixed PC board 260. A second transmission line 360 having a second arcuate portion 370, a first path 380, and a second path 390 is also electrically connected to the input 300. The second rotatable PC board 350 glides over the second arcuate portion 370 to create the capacitor. The second rotatable PC board 350 is moved by the actuator (discussed below) and is connected to the actuator at a joint 395 located in a second slot 405 in the fixed PC board 260. The first path 380 of the second transmission line 360 is connected to a second output 400, which is coupled to the second antenna 120 (FIG. 1), while the second path 390 of the second transmission line 360 is connected to a fourth output 410, which is coupled to the fourth antenna 140. As with the first phase adjuster 200, the lengths of the first and second paths 380, 390 are adjusted to create the proper default phase angle.

Also connected to the input 300 is a third transmission line 420, which is coupled to a third output 430, which is connected to the third antenna 130. The third transmission line 420 is of a length to create the proper default phase angle. Since all of the individual paths 330, 340, 380, 390, 420 of the various transmission lines 240, 360, 420 are adjusted to create the proper default phase angle, the same length cable can be used to connect the antennas 110, 120, 130, 140, 150 to their respective outputs 310, 400, 430, 410, 320. This not only makes manufacturing easier, it also eliminates the possibility of error during installation of connecting the wrong length cable to the output.

The amount of power supplied to the phase adjusters also affects the phase angles of the antennas 110, 120, 130, 140, 150. The input 300 is connected to a conductive strip 440 which acts as a power divider and bleeds off power to the first and second phase adjusters 200, 210 and the third transmission line 420. The conductive strip 440 has an established impedance. The impedance of the strip 440 is a function of the width of the strip 440. By changing the width of the conductive strip 440, the impedance and, thus, the power is changed. In the present invention, the conductive strip 440 branches into a first strip 450, a second strip 460, and a third strip 470. The first strip 450 transfers power from the conductive strip 440 to the first phase adjuster 200. The second strip 460 transfers power from the conductive strip 440 to the second phase adjuster 210, and the third strip 470 transfers power from the conductive strip 440 to the third transmission line 420. The width of each of the first, second, and third strips 450, 460, 470 is manufactured to draw the correct amount of power from the conductive strip (or power divider) 440. By using a power divider on the fixed PC board 260, excess cables are eliminated, which decreases cost and also increases the reliability of the antenna assembly 100. In another embodiment of the present invention, a conductive strip can be included to divide power on the first and second transmission lines 240, 360 along the arcuate portions 230, 370.

It is sometimes desirable to lock the first and second phase adjusters in a permanent position. In current systems, a phase adjuster was locked into position at the time of manufacture since the phase adjuster does not include markings or the like.

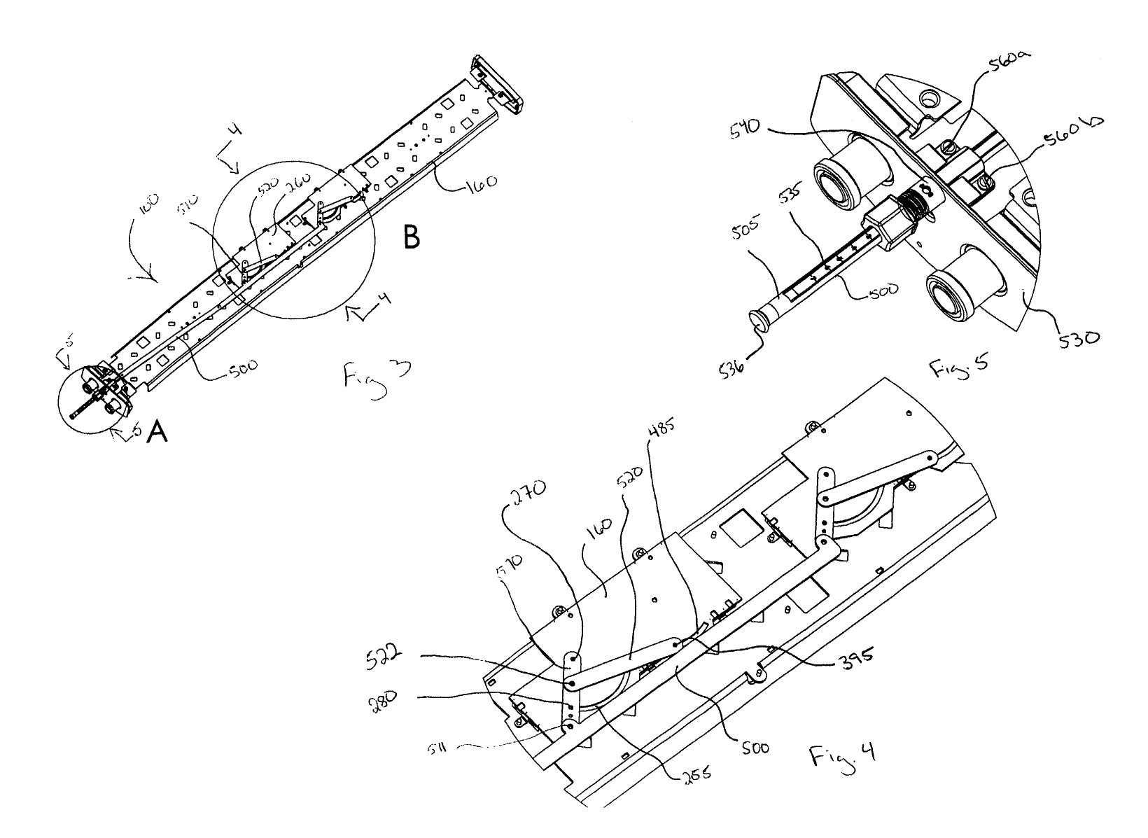

In one embodiment of the present invention, however, the fixed PC board 260 includes a first set of markers 480a over the first slot 255 and a second set of markers 480b over the second slot 405. The sets of markers 480a, 480b provide a user with a method for viewing the phase angle settings of the first and second phase adjusters 200, 210. A locking mechanism 485 is included to lock the first and second phase adjusters 250, 350 in a set position. In one embodiment, a series of through holes 490a, 490b may also be included on the fixed PC board 260 and align with through holes 495a, 495b on the first and second rotatable PC boards 250, 350. A screw (not shown) may be used to lock the first or second first rotatable PC board 250, 350 to the fixed PC board 260. The use of markings and a lock system is a great improvement because the fixed PC board 260 can be assembled to the first and second phase adjusters 200, 210 without knowing if the phase angles need to be locked. Thus, this device may be manufactured prior to a purchase order being received. Once a purchase order is made, the markings and lock system can be used to lock the first and second phase adjusters 200, 210 in place, if so desired. Turning now to FIGS. 2-4, FIG. 2 depicts a front side of the fixed PC board 260. FIG. 3 depicts a perspective view of a side of the panel 160 of the antenna assembly 100 and a back side of the fixed PC board 260. FIG. 4 is an enlarged view of section 4-4 of FIG. 3. In FIGS. 3 and 4, two pairs of first and second phase adjusters 200, 210 are shown. Both pairs operate in the same fashion, and are only illustrated to demonstrate that more than one antenna assembly 100 may be mounted on a single panel. As discussed above, the first phase adjuster 200 comprises the fixed PC board 260 with the first arcuate slot 255 cut through and the first rotatable PC board or wiper 250 (FIG. 2) on the other side of the fixed PC board 260. The second phase adjuster 210 comprises the fixed PC board 260, the second rotatable PC board or wiper 350 (FIG. 2), and the second arcuate slot 485. To cause the first and second rotatable PC boards 250, 350 to rotate, an actuator is coupled to the rotatable PC boards 250, 350.

In one embodiment, the actuator comprises an actuator rod 500, a first arm 510, and a second arm 520. The actuator rod 500 is connected to one end of the first arm 510 at a pivot point 511. The other end of the first arm 510 is connected to the fixed PC board 260 and the first rotatable PC board 250 at the joint 270. A crosssection of this joint 270 would show there are three layers all connected, the first rotatable PC board 250, the fixed PC board 260, and the first arm 510. Since the fixed PC board 260 is stationary, the first arm 510 and the first rotatable PC board 250 also remain fixed at the joint 270. The joint 280 connects the first rotatable PC board 250 to the first arm 510 through the first slot 255 on the fixed PC board 260.

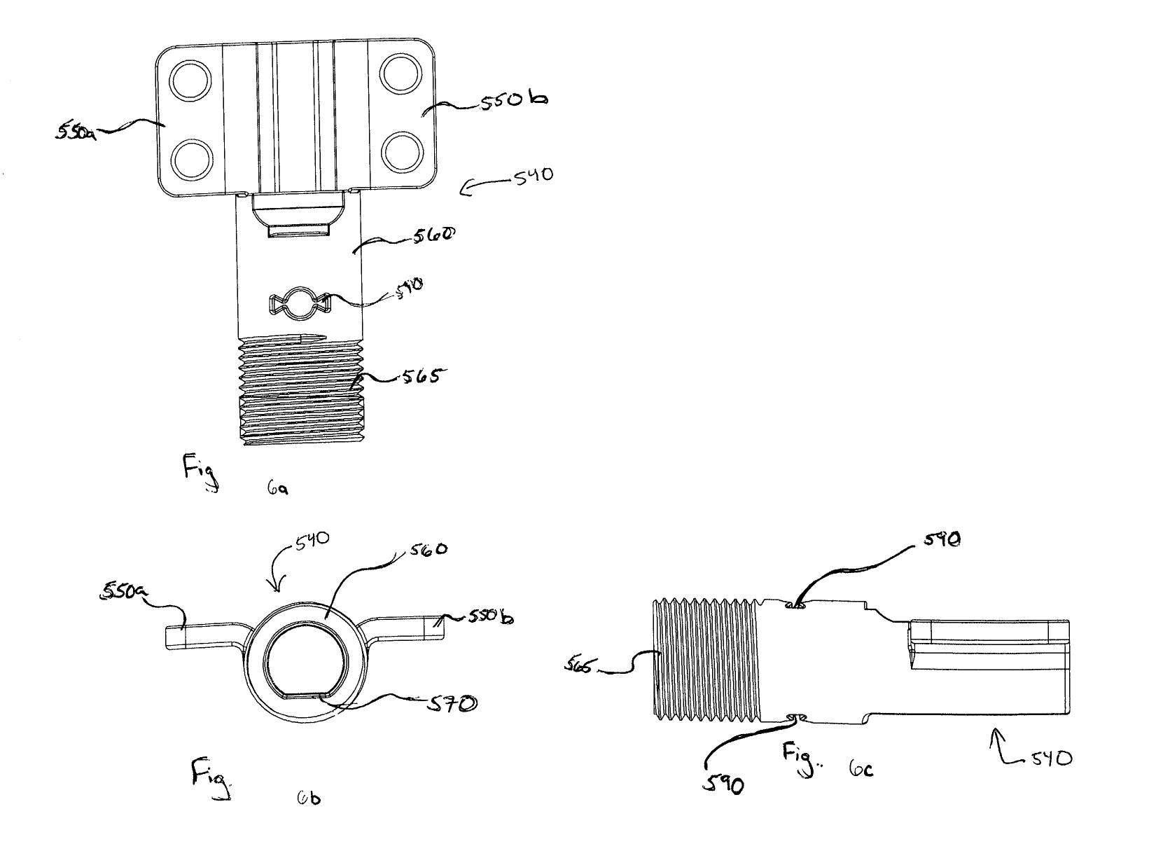

The second arm 520 is connected to the second rotatable PC board 350 through the second slot 405 at the joint 395. Thus, a movement of the second arm 520 causes the second rotatable PC board 350 to move along the second slot 405. The second arm 520 is also rotatably connected at a joint 522 to approximately midway between joint 270 and joint 280 on the first arm 510. Thus, as the first arm 510 is moved, the second arm 520 also moves. Since the second arm 520 is linked to the first arm 510 at the midpoint, as the joint 512 of the first arm 510 moves a predetermined distance, the joint 395 of the second arm 520 moves approximately half the predetermined distance. In other embodiments, the second arm 520 may be attached at different locations over the first arm 510, depending upon the desired ratio of movement between the first and second phase adjusters 200, 210. FIG. 5 illustrates a grasping end 505 of the actuator rod 500 that extends out past a bottom 530 of the panel 160. The grasping end 505 of the actuator rod 500 is affixed to the bottom 530 of the panel 160. By extending the actuator rod 500 out through the bottom 530 of the panel 160, a person manually adjusting the mechanism only has to pull or push on the actuator rod 500, instead of having to rotate a small knob or disc located on the side of the panel 160, as done in the prior art. Also included on the grasping end 505 of the actuator rod 500 are markings 535 to indicate the amount of adjustment made by a person adjusting the mechanism, and a knob 536 is shown covering a threaded end 538 of the actuator rod 500. The markings 535 have a direct relationship to the vertical downtilt angle of the beam. For example, a zero marking on the rod correlates to a zero degree downtilt angle. Since the markings 535 are not detented, a user may adjust the downtilt angle as much or as little as needed. The downtilt angle need not be moved in degree or half degree increments. The knob 536 screws onto the threaded end 538 and enables the user to easily grasp the actuator rod 500 for movement purposes.

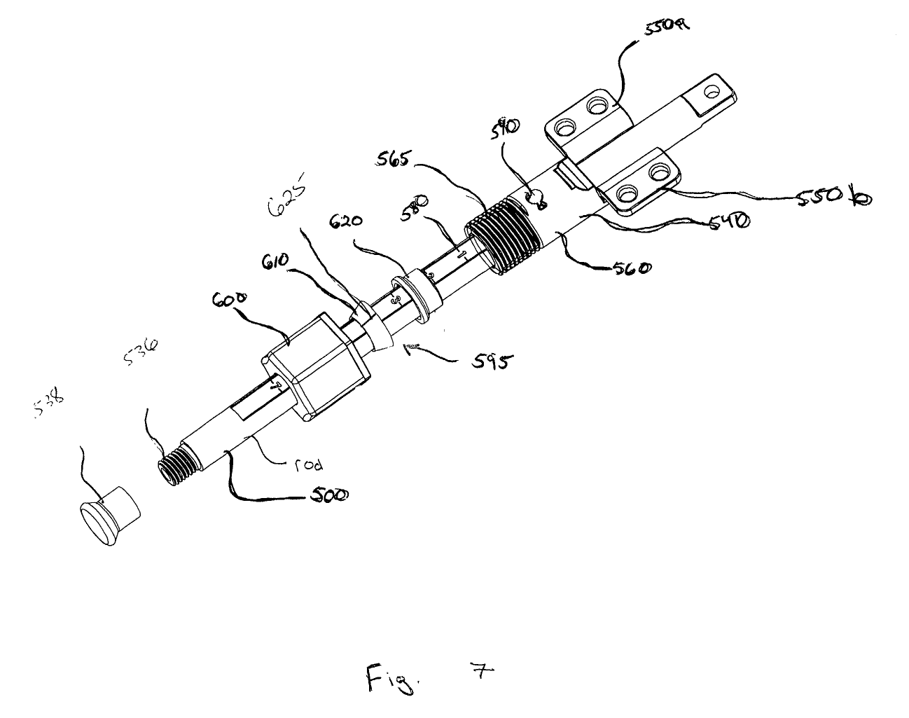

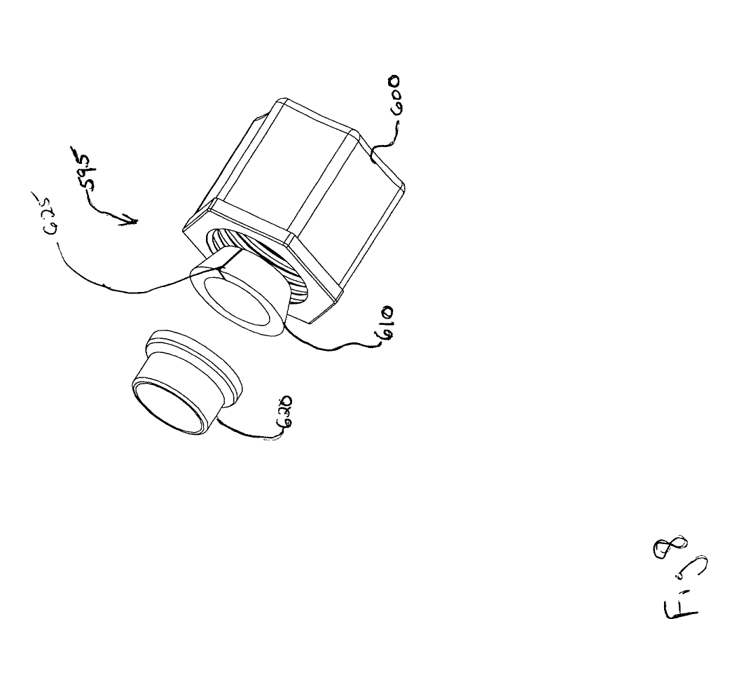

The actuator rod 500 is mounted onto the bottom 530 of the panel 160 by a bushing mount 540. The bushing mount 540 is best illustrated in FIGS. 6a-6c. The bushing mount 540 comprises a pair of brackets 550a, 550b which are attached to the panel 160. In the embodiment shown, the brackets 550a, 550b are attached via a pair of screws 560a, 560b (shown in FIG. 5). It is also contemplated, however, that other methods, such as rivets, adhesive heat staking, welding, and brazing, may be utilized.

The bushing mount 540 also has a cylindrical portion 563 adapted to receive the actuator rod 500. The cylindrical portion 563 of the bushing mount 540 allows the actuator rod 500 to be slid up and down, enabling movement. To prevent the actuator rod 500 from rotating within the cylindrical portion 563, however, a flat section 570 (FIG. 6b) is included on the inner wall of the cylindrical portion 563. One end of the cylindrical portion 563 includes a threaded portion 565 which will be described in more detail below.

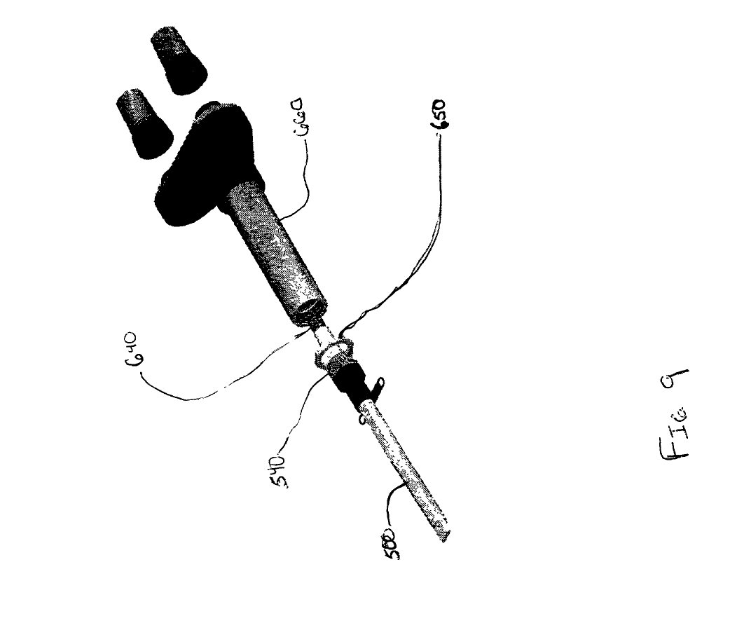

As mentioned above, the grasping end 505 of the actuator rod 500 includes markings 535. The bushing mount 540 includes an indicator window 590 on opposite sides of the cylindrical portion 563 to enable a user to see the markings 535 (seen in FIG. 6c). Also, in one embodiment, the bushing mount 540 is clear so that all of the markings 535 are visible to the user. As shown in FIGS. 7 and 8, a compression nut 595 is also slid over the actuator rod 500. The compression nut 595 includes three parts, a threaded nut 600, a plastic gripper 610, and a ferrule 620. The threaded nut 600 of the compression nut 595 screws over the threaded portion 565 of the bushing mount 540 and acts to lock the actuator rod 500 in place. When the threaded nut 600 is being screwed over the threaded portion 565 of the bushing mount 540, the plastic gripper 610 and the ferrule 620 are sandwiched against the bushing mount 540. The ferrule acts as a seal against the bushing mount 540. The plastic gripper 610 contains a slit 625, which decreases in width as the threaded nut 600 is tightened against the bushing mount 540. This causes the compression nut 595 to grip the bushing mount 540, and lock the actuator rod 500 in place.

Although it is useful to have a manual actuator, it may be more desirable to a have an electrical actuator that may be controlled from the ground or even remotely, for example, from a control room. In FIG. 9, converting the manual actuator is described above into an electrical actuator 660 is illustrated. The electrical actuator 600 comprises a piston (not shown) and a threaded barrel 670. To convert the manual actuator, the compression nut 595 and the knob 536 must first be removed. Then, a lock nut 650 is threaded onto the bushing mount 540. The threaded end 538 of the actuator rod 500 is threaded into the piston. The barrel 670 of the electrical actuator 660 is then pushed up towards the threaded portion 565 of the bushing mount 540 and threaded. Once both the piston and the threaded barrel are completely threaded onto the actuator rod 500, the lock nut 650 is tightened, locking the bushing mount 540 to the threaded barrel 670.

The electrical actuator 660 may be a step motor in a fixed position relative to the panel 160. The step motor rotates, driving a screw or shaft in a linear motion. The screw or shaft is coupled to the actuator rod 500 and, thus, moves the actuator rod 500 up and down, depending on the rotation of the step motor. It is also contemplated that the electrical actuator 660 may include a receiver adapted to receive adjustment signals from a remote source. A sensor adapted to sense the position of the actuator rod may also be included. A transponder may also be included to return a signal to the remote location or to a signal box which indicates the amount of adjustment made.

The present invention may, thus, be easily converted from a manual actuator to an electrical actuator depending on the needs and wishes of the user. The actuator, thus, provides flexibility in use, allowing a user to purchase a manual actuator and then upgrading to an electrical actuator at a later date. The advantages to this are many. The user may not initially wish to expend the money to pay for an electrical actuator if there is rarely a need to adjust the vertical beam. As that need changes, however, the user may purchase the electrical actuator and easily convert the actuator.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. An antenna assembly for emitting a signal, the antenna assembly comprising:
at least two antennas separated into a first group and a second group, said at least two antennas mounted on a panel;
a first phase adjuster coupled to said first antenna group and adapted to adjust a phase angle of the signal of one antenna in said first antenna group;
a second phase adjuster coupled to said second antenna group and adapted to adjust a phase angle of the signal of one antenna in said second antenna group, wherein said second phase adjuster is coupled to said first phase adjuster, such that an adjustment of said first phase adjuster adjusts said second phase adjuster; and
an actuator engaged on a bottom of said panel, when a movement of said actuator causes said first phase adjuster to move.

2. The antenna assembly of claim 1, wherein said first and second phase adjusters include a linkage assembly, and said second phase adjuster is rotatably coupled to said first phase adjuster.

3. The antenna assembly of claim 1, wherein said adjustment of said first phase adjuster simultaneously adjusts said second phase adjuster.

4. The antenna assembly of claim 1, wherein said actuator is slidably engaged to said panel.

5. The antenna assembly of claim 1, wherein said actuator is rotatably attached to said first phase adjuster.

6. The antenna assembly of claim 1, wherein said actuator is slidably engaged on said bottom side of said panel.

7. The antenna assembly of claim 1, wherein said actuator includes an actuator rod.

8. The antenna assembly of claim 7, wherein said actuator further includes a linkage assembly.

9. The antenna assembly of claim 7, wherein said actuator rod further comprises markings adapted to provide an indication of the vertical radiation pattern downtilt angle.

10. The antenna assembly of claim 7, wherein said actuator rod further comprises a removable knob adapted to enable a user to grasp and slide said actuator rod.

11. The antenna assembly of claim 1, wherein said actuator further comprises a position lock, said position lock adapted to lock said actuator into a position.

12. The antenna assembly of claim 11, wherein said position lock comprises a compression nut.

13. The antenna assembly of claim 12, wherein said compression nut comprises a threaded nut adapted to engage said actuator, a ferrule, and a gripper having a slit with an initial width, wherein as said threaded nut engages said actuator, said slit has a decreased width, enabling said gripper to grip the actuator rod.

14. The antenna assembly of claim 1, wherein said actuator comprises a mounting mechanism adapted to mount said actuator onto said panel.

15. The antenna assembly of claim 14, wherein said mounting mechanism is a bushing mechanism.

16. The antenna assembly of claim 14, wherein said bushing mount comprises a flat portion on an inner surface of said bushing mount, and said actuator rod fuirther comprises a flat portion, said flat portion of said bushing mount adapted to prevent rotation of said actuator.

17. The antenna assembly of claim 14, wherein said actuator further includes a plurality of markings indicating a phase angle of the signal, and said bushing mount comprises an indicator window to enable a reading of said markings.

18. The antenna assembly of claim 17, wherein said bushing mount is clear to enable a reading of said markings.

19. The antenna assembly of claim 1, wherein said actuator is adapted to be connected to an electrical actuator, such that said actuator is moved by said electrical actuator.

20. The antenna assembly of claim 19, wherein said actuator comprises a threaded end, adapted to be threaded into a piston of said electrical actuator, a bushing mount adapted to be threaded into a threaded end of said electrical actuator, and a locking mechanism adapted to lock said actuator to said electrical actuator.

21. The antenna assembly of claim 20, wherein said locking mechanism is a lock nut.

22. A phase adjusting assembly for emitting a signal of an antenna assembly having at least two antennas separated into a first group and a second group, each of the at least two antennas having a different phase angle of a signal, said phase adjusting assembly comprising:
a first phase adjuster coupled to the first antenna group and adapted to change the phase angle of an antenna in the first group;
a second phase adjuster coupled to the second antenna group and adapted to change the phase angle of an antenna in the second group, said second phase adjuster coupled to said first phase adjuster, such that an adjustment of said first phase adjuster causes a proportional adjustment of said second phase adjuster; and
an actuator connected to said first phase adjuster, such that a movement of said actuator causes an adjustment of said first phase adjuster.

23. The phase adjusting assembly of claim 22, wherein said first phase adjuster comprises:
a fixed PC board;
an input mounted on said fixed PC board;
s a first wiper electromagnetically coupled to said input; and
a first transmission line electromagnetically coupled to said first wiper and to the first antenna group;
wherein a movement of said first wiper changes an effective length of said first transmission line.

24. The phase adjusting assembly of claim 23, wherein said first wiper is pivotally coupled to said input.

25 The phase adjusting assembly of claim 23, wherein said first wiper is a rotatable PC board.

26. The phase adjusting assembly of claim 23, wherein said first transmission line is arcuate in shape.

27. The phase adjusting assembly of claim 26, wherein said first wiper comprises an arcuate section having substantially the same radius of curvature as said first arcuate transmission line, such that as said first wiper is pivoted over said first transmission line, said first wiper remains substantially in alignment with said first transmission line.

28. The phase adjusting assembly of claim 23, wherein the first antenna group includes a first antenna and a second antenna, and said effective length is a length of said first transmission line from said first wiper to one of the first and second antenna.

29. The phase adjusting assembly of claim 23, wherein said second phase adjuster comprises:
said fixed PC board;
said input mounted on said fixed PC board;
a second wiper electromagnetically coupled to said input; and
a second transmission line electromagnetically coupled to said second wiper and to the second antenna group;
wherein a movement of said first wiper changes an effective length of said second transmission line.

30. The phase adjusting assembly of claim 29, wherein said second wiper is rotatably coupled to said input.

31. The phase adjusting assembly of claim 29, wherein said second wiper is a rotatable PC board.

32. The phase adjusting assembly of claim 31, wherein said second transmission line is arcuate in shape.

33. The phase adjusting assembly of claim 32, wherein said second wiper comprises an arcuate section having substantially the same radius of curvature as said second arcuate transmission line, such that as said second wiper is pivoted over said second transmission line, said second wiper remains substantially in alignment with said second transmission line.

34. The phase adjusting assembly of claim 29, wherein the second antenna group includes a first antenna and a second antenna, and said effective length is a length of said second transmission line from said second wiper to one of the first and second antenna.

35. The phase adjusting assembly of claim 29, the antenna assembly further has a third group of antennas, wherein said phase adjusting assembly includes a third transmission line electromagnetically coupling said input to the third group of antennas.

36. The phase adjusting assembly of claim 35, wherein said fixed PC board further comprises a power divider adapted to divide power at said input to said first transmission line, said second transmission line, and said third transmission line.

37. The phase adjusting assembly of claim 35, wherein said fixed PC board ftirther comprises a power divider adapted to divide power from said input to each of the at least two antennas, such that each of the at least two antennas has a specific phase angle.

38. The phase adjusting assembly of claim 36, wherein said first, second, and third transmission lines are arranged, such that a different amount of phasing is established for each of said at least two antennas.

39. The phase adjusting assembly according to claim 22, wherein said actuator is pivotally connected to said first phase adjuster.

40. The phase adjusting assembly according to claim 22, wherein said actuator includes a linkage assembly.

41. A method for adjusting a downtilt angle of an antenna assembly having a first antenna group and a second antenna group, said method comprising the steps of:
attaching a first phase adjuster to said first antenna group, such that an adjustment of said first phase adjuster changes a phase of an antenna in said first antenna group;
attaching a second phase adjuster to said second antenna group, such that an adjustment of said second phase adjuster changes a phase of said second phase adjuster;
attaching said second phase adjuster to said first phase adjuster, such that an adjustment of said first phase adjuster causes an adjustment of said second phase adjuster;
attaching said first phase adjuster to an actuator, such that an adjustment of said actuator causes an adjustment of said first phase adjuster; and
adjusting said actuator a predetermined amount until said desired downtilt angle is obtained.

42. The method according to claim 41, wherein a transmission line is attached at an end of said first phase adjuster.

43. The method according to claim 42, wherein said actuator is attached to another end of said first phase adjuster.

44. The method according to claim 41, wherein said second antenna group is attached to an end of said second phase adjuster.

45. The method according to claim 44, wherein said first phase adjuster is attached to another end of said second phase adjuster.

46. A method of converting a manual actuator for manually adjusting a downtilt of an antenna assembly to an electrical actuator having a piston and a threaded end, the electrical actuator adapted to electrically adjusting the downtilt of the antenna assembly, said method comprising the steps of:
threading an end of the manual actuator into the piston of the electrical actuator;
threading a bushing mount affixed to said manual actuator onto the threaded end of the electrical actuator; and
locking said manual actuator to said electrical actuator.

47. An antenna assembly for emitting a signal, the antenna assembly comprising:
at least two antennas separated into a first group and a second group, said at least two antennas mounted on a panel; and
a board mounted on said panel, said board comprising a power splitter adapted to provide power to said first and second antenna groups, a first phase adjuster adapted to adjust a phase angle of an antenna in said first antenna group, and a second phase adjuster coupled to said first phase adjuster, said second phase adjuster adapted to adjust a phase angle of an antenna in said second antenna group.

48. An antenna assembly for emitting a signal, the antenna assembly comprising:
a plurality of antennas mounted on a panel;
a board mounted on said panel, wherein said board comprises a plurality of transmission lines each dedicated to one of said plurality of antennas, said plurality of transmission lines having different lengths to vary the phase angles of said plurality of antennas;
a first phase adjuster mounted on said board and capable of adjusting an effective length of one of said plurality of transmission lines; and
a second phase adjuster mounted on said board and coupled to said first phase adjuster, said second phase adjuster capable of adjusting an effective length of another of said plurality of antennas.

49. An antenna assembly, comprising:
a plurality of antennas separated into a first group and a second group, said plurality of antennas mounted on a panel;
a phase adjusting mechanism adapted to adjust the phase of said plurality of antennas; and
a manual actuator connected to said phase adjusting mechanism, adapted to be manually activated to position said phase adjusting mechanism, said manual actuator further adapted to be able to be connected to an electrical actuator to electrically position said phase adjusting mechanism.

50. The antenna adjusting assembly of claim 49, wherein said phase adjusting mechanism includes:
a first phase adjuster; and
a second phase adjuster;
wherein said actuator comprises:
an actuator rod coupled to said panel;
a first arm coupled to said actuator rod and coupled to said first phase adjuster; and
a second arm coupled to said first arm and coupled to said second first phase adjuster.

51. The antenna adjusting assembly of claim 50, wherein said first arm is rotatably coupled to said actuator rod.

52. The antenna adjusting assembly of claim 50, wherein said second arm is rotatably coupled to said first arm.

53. The antenna adjusting assembly of claim 50, wherein said first phase adjuster comprises a fixed PC board and a first rotatable PC board, wherein said first rotatable PC board is coupled to said first arm.

54. The antenna adjusting assembly of claim 53, wherein said second phase adjuster comprises said fixed PC board and a second rotatable PC board, wherein said second rotatable PC board is coupled to said second arm.

55. The antenna adjusting assembly of claim 54, wherein said second arm is coupled to said first arm, such that a movement of said first arm a distance causes said second arm to move a predetermined fraction of the distance.

56. The antenna adjusting assembly of claim 55, wherein said predetermined fraction is one half

57. The antenna adjusting assembly of claim 53, wherein said fixed PC board further comprises a first arcuate slot through which said first rotatable PC board moves with respect to said actuator.

58. The antenna adjusting assembly of claim 57, wherein said fixed PC board further comprises a second arcuate slot through which said second rotatable PC board moves with respect to said actuator.

59. The antenna adjusting assembly of claim 57, wherein said first arcuate slot defines a range of motion of said first rotatable PC board.

60. The antenna adjusting assembly of claim 58, wherein said second arcuate slot defines a range of motion of said second rotatable PC board.

61. The antenna adjusting assembly of claim 60, wherein said fixed PC board further comprises a plurality of markings over said first and second arcuate slots, indicating a phase angle.

62. The antenna adjusting assembly of claim 54, wherein said fixed PC board further comprises a lock adapted to lock said first and second rotatable PC boards in a predetermined position.

63. The antenna adjusting assembly of claim 62, wherein said lock comprises a first screw adapted to engage said fixed PC board and said first rotatable PC board, and a second screw adapted to engage said fixed PC board and said second rotatable PC board.

64. The antenna assembly of claim 49, wherein said first antenna group comprises one antenna.

65. The antenna assembly of claim 49, wherein said first antenna group comprises two antennas.

66. The antenna assembly of claim 49, wherein said second antenna group comprises one antenna.

67. The antenna assembly of claim 49, wherein said second antenna group comprises two antennas.

68. The antenna assembly of claim 49, fuirther comprising a third group of antennas.

69. The antenna assembly of claim 68, wherein said third group of antennas comprises one antenna.

70. The antenna assembly according to claim 49, wherein said manual actuator comprises an actuator rod having a threaded end and a bushing mount having a threaded end, said bushing mount capable of mounting said actuator rod to said panel.

71. The antenna assembly according to claim 70, wherein said electrical actuator has a threaded piston capable of receiving said threaded end of said actuator rod.

72. The antenna assembly according to claim 70, wherein said electrical actuator includes a threaded barrel capable of receiving said threaded end of said bushing mount.

73. The antenna assembly according to claim 49, wherein said manual actuator further comprises a lock adapted to lock said manual actuator and said electrical actuator together.

74. An antenna assembly having a radiation pattern and a vertical radiation pattern downtilt angle with respect to the surface of the earth, the antenna assembly comprising:
a plurality of antennas mounted on a panel;
a board mounted on said panel; and
a first phase adjuster mounted on said board and adapted to adjust a phase angle of said plurality of antennas, said first phase adjuster having a first arcuate transmission line and a first wiper electromagnetically coupled with said first transmission line and having an arcuate cross-section adapted to have substantially the same radius of curvature of said first arcuate transmission line.

75. The antenna assembly of claim 74, wherein said first wiper moves in substantial alignment along said first arcuate transmission line.

76. A method for adjusting a phase angle of a first antenna and a second antenna, comprising the steps of providing a first phase adjuster comprising a board, a first transmission line on said board, said first transmission line having a finite length, and a wiper adapted to move along said finite length of said transmission line;
coupling one end of said first transmission line to said first antenna, wherein said first transmission line has a first effective length measured from said end to said wiper;
coupling another end of said first transmission line to said second antenna, wherein said first transmission line has a second effective length measured from the other end to said wiper;
coupling said wiper to an electric actuator; and
moving said wiper over said transmission line to adjust said first and second a, effective lengths;
wherein one part of said first and second effective lengths is capable of having a common section.

77. The method of claim 76, further comprising coupling said first phase adjuster to an actuator rod.

78. The method of claim 77, further comprising coupling said first phase mechanism to a linkage assembly.

79. An antenna, comprising:
a plurality of radiators;
a transmission line interconnecting said radiators; and
a phase adjustment system for varying the relative phasing of said interconnected radiators, said phase adjustment system comprising:
PC board means having a printed conductor comprising part of said transmission line; and
variable means connected to a feed and coupled to said printed conductor for varying the relative phasing of said interconnected radiators.

80. The antenna defined by claim 79, wherein said variable means comprises a second PC board pivotally connected to said first-named PC board and having a second printed conductor capacitively coupled to said first-named printed conductor.

81. An antenna comprising:
a plurality of radiators;
a transmission line interconnecting said radiators;
a phase adjustment system for varying the relative phasing of said interconnected radiators, said phase adjustment system comprising:
PC board means having a printed conductor comprising part of said transmission line; and
variable means connected to a feed and coupled to said printed conductor for varying the relative phasing of said interconnected radiators; and
a power divider printed on said printed circuit board between said feed and said variable means.

82. An antenna, comprising:
a plurality of radiators;
printed circuit board means; and
a network of transmission lines connecting a feed to each of said radiators, each of said lines including a printed conductor trace on said printed circuit board, said traces having differing trace lengths to alter the default phasing of said radiators.

83. The antenna defined by claim 82, wherein said network of lines includes a plurality of coaxial cables of equal length.

84. An antenna, comprising:
a plurality of radiators;
printed circuit board means;
a network of transmission lines connecting a feed to each of said radiators, each of said lines including a printed conductor trace on said printed circuit board means, said traces having differing trace lengths to alter the default phasing of said radiators; and
a power divider printed on said printed circuit board between said feed and said network.

85. The antenna defined by claim 84, wherein said network of lines includes a plurality of coaxial cables of equal length.

86. An antenna, comprising:
a plurality of radiators;
printed circuit board means;
a network of transmission lines connecting a feed to each of said radiators, each of said lines including a printed conductor trace on said printed circuit board means, said traces having differing trace lengths to alter the default phasing of said radiators; and
a phase adjustment system capacitively coupled into said traces for varying the relative phasing of selected ones of said radiators.
